(19) United States
(12) Patent Application Publication
(10) Pub. No.: US 2012/0147590 A1
(43) Pub. Date: Jun. 14, 2012

(54) LED TUBE

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/287,217

(22) Filed: Nov. 2, 2011

(30) Foreign Application Priority Data
Dec. 8, 2010 (TW) 099142711

(51) Int. Cl. F21V 9/16

(52) U.S. Cl. 362/84

(57) ABSTRACT

A light emitting diode (LED) tube is disclosed. The LED tube comprises a print circuit board comprising a plurality of LEDs arranged on one side; a housing adapted to receive the print circuit board, the housing comprises a first phosphor layer and a second phosphor layer coated on an outer surface of the housing, the housing is rotatable around the print circuit board; and a connector attached to one end of the housing, the connector is adapted to provide electrical power to the plurality of LEDs.

### TECHNICAL FIELD

The disclosure generally relates to a light emitting diode tube.

### DESCRIPTION OF RELATED ART

In recent years, due to excellent light quality and high luminous efficiency, light emitting diodes (LEDs) have increasingly been used to substitute for incandescent bulbs, compact fluorescent lamps, or fluorescent tubes as light sources of illumination devices.

One characteristic of color is the color temperature, which is the temperature at which an ideal black-body radiator radiates light of comparable hue to that of the light source. Users may like to have light with different color temperatures depending on different ambiances. For example, users may like to have white light with a bit of yellow at one time, but may like to have white light with a bit of blue at another time. However, the color temperature of a lamp may be a fixed character of the light source at the time of manufacturing and may not be adjusted by the users.

Therefore, an LED tube is desired to overcome the above described shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric, assembled view of an LED tube in accordance with one embodiment of the present disclosure.

FIG. 2 is an exploded view of the LED tube in FIG. 1.

FIG. 3 is a cross-sectional view of the LED tube in FIG. 1.

FIG. 4 is a cross sectional view of the LED tube in FIG. 1, wherein a housing of the LED tube is rotated to a first position.

FIG. 5 is a cross-sectional view of the LED tube in FIG. 1, wherein the housing of the LED tube is rotated to a second position.

### DETAILED DESCRIPTION

Embodiments of an LED tube will now be described in detail below and with reference to the drawings.

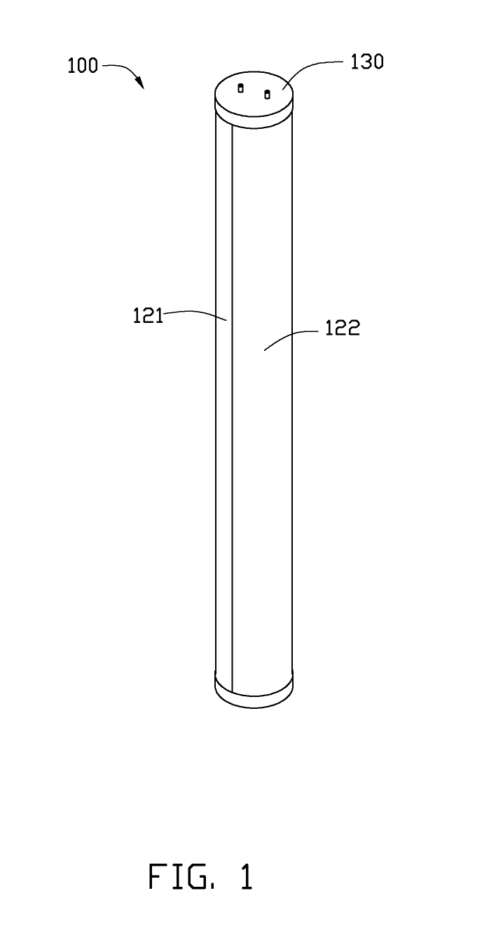

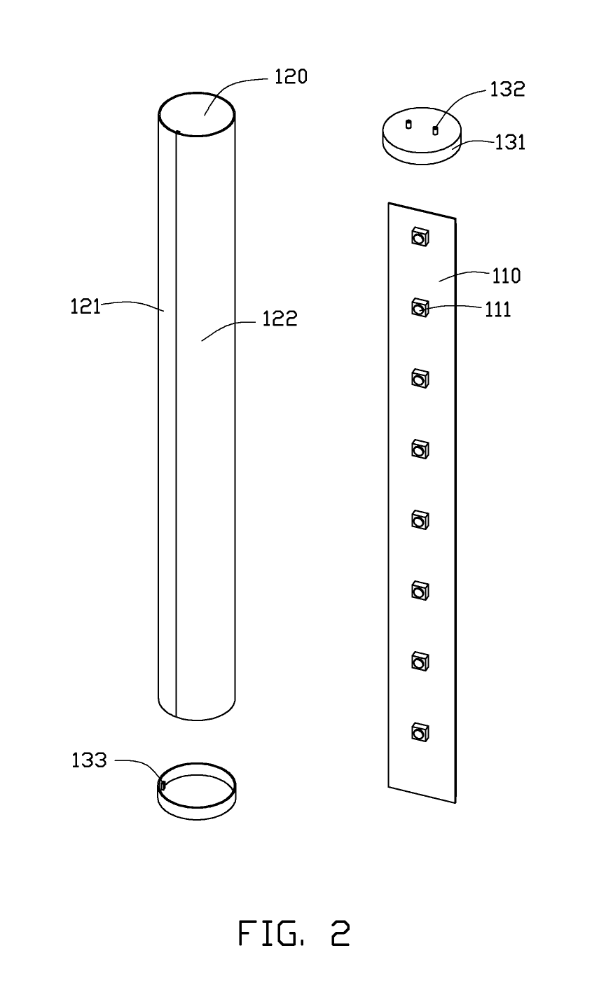

Referring to FIGS. 1-2, an LED tube 100 in accordance with an embodiment includes a print circuit board 110, a housing 120 for receiving the print circuit board 110 and a connector 130 connected to each end of the housing 120.

The print circuit board 110 may be elongated and rectangular. Preferably, the print circuit board 110 is Al-based print circuit board with good heat dissipation. A length of the print circuit board 110 may be substantially the same as that of the housing 120, while a width of the print circuit board 110 may be slightly less than that of the housing 120. A plurality of LEDs 111 may be arranged on the print circuit board 110. In one embodiment, the plurality of LEDs 111 is arranged on one side of the print circuit board 110 in a direction of the length of the printed circuit board 110.

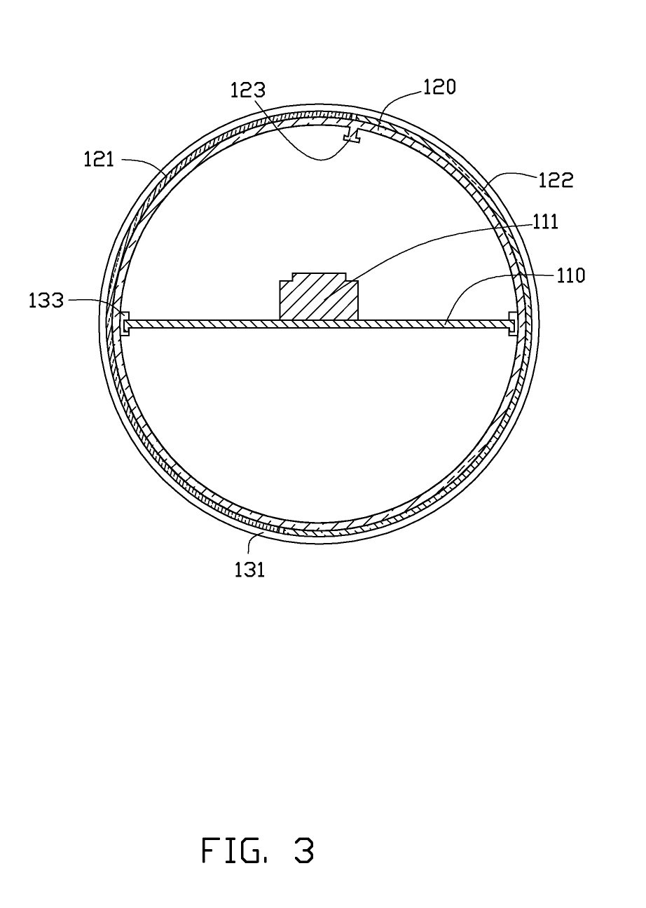

The housing 120 may be tubular and made of transparent or semi-transparent materials such as polycarbonate (PC) and polymethyl methacrylate (PMMA). A first phosphor layer 121 and a second phosphor layer 122 are arranged on different portions of an outer surface of the housing 120. The first phosphor layer 121 and a second phosphor layer 122 are semi-circle cylinder shaped and made of different materials, thereby different colors of light may be generated when the light from the plurality of LEDs 111 passes through the first phosphors layer 121, and/or second phosphor layers 122. In one embodiment, each of the phosphor layer 121 and the second phosphor layer 122 covers substantially one half of the outer surface of the housing 120, so that the combination of the first and second phosphor layers 121 and 122 covers the entire outer surface of the housing 120. Referring also to FIG. 3, the first phosphor layer 121 and the second phosphor layer 122 are symmetric to a plane on which a longitudinal central axis of the housing 120 is located. A protrusion 123 may be formed at an inner wall of the housing 120 to limit a rotating angle of the housing 120 relative to the plurality of LEDs 111. In one embodiment, the protrusion 123 is aligned with a joint of the first phosphor layer 121 and the second phosphor layer 122.

One connector 130 may be attached to each end of the housing 120. Each connector 130 may include a base 131 and two electrode pins 132 extending through the base 131 for electrically connecting the plurality of LEDs 111 to an external power source. Referring also to FIG. 3, two securing sections 133 may be formed on an inner sidewall of the base 131 to secure the print circuit board 110 to the base 131. The base 131 may has an inner diameter substantially the same as an outer diameter of the housing 120 and the multiple layers of difference phosphors deposited on the outer surface of the housing 120. The securing section 133 may be located on an imaginary circle having a diameter substantially the same as an inner diameter of the housing 120 and is homocentric as the base 131. A gap is defined between an outer edge of the base 131 and the securing section 133 for receiving the housing 120.

To assemble the LED tube 100, the printed circuit board 110 with the plurality of LEDs 111 arranged thereon may be inserted into the housing 120, one connector 130 may be attached to each end of the housing 120 with the securing sections 133 aligned with edges of the printed circuit board 120, and each end of the print circuit board 110 may be securely attached to one connector 130 by the securing sections 133. In one embodiment, each end of the housing 120 may be received in the gap between the base 131 and the securing section 133 such that the housing 120 may be rotated freely around the connector 130 and the print circuit board 110.

Referring to FIG. 3, the housing 120 may be rotated so that the plurality of LEDs face the first phosphor layer 121 and the second phosphor layer 122 synchronously, i.e., both the first phosphor layer 121 and the second phosphor layer 122 are in an illuminating area of the plurality of LEDs 111. FIG. 3 shows an embodiment wherein a surface area of the first phosphor layer 121 facing the plurality of LEDs 111 is same as that of the second phosphor layer 122. In other embodiments, the housing 120 may be rotated to achieve different ratios of coverage areas between the first phosphor layer 121 and the second phosphor layer 122 in the illuminating area of the plurality of LEDs 111.

When a voltage is applied to the plurality of LEDs 111, the plurality of LEDs 111 emit light with a first wavelength. The first phosphor layer 121 absorbs part of the light with the first wavelength and emits light with a second wavelength different from the first wavelength. The second phosphor layer 122 absorbs part of the light with the first wavelength and emits light with a third wavelength different from either of the first wavelength and second wavelength. Light with the first wavelength from the LEDs 111, light with the second wavelength from the first phosphor layer 121, and light with the third wavelength from the second phosphor 122 are mixed together to form mixed light with a first color temperature different from that of the light directly from the plurality of LEDs 111.

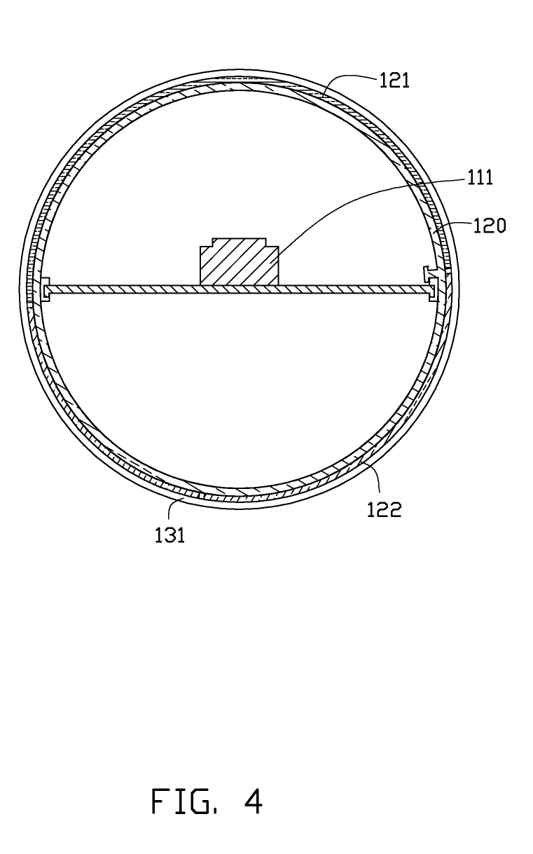

Referring to FIG. 4, to adjust the color temperature of the LED tube 100, the housing 120 may be rotated to a position where plurality of the LEDs 111 only face the first phosphor layer 121, i.e., only the first phosphor layer 121 is in the illuminating area of the plurality of LEDs 111. The first phosphor layer 121 absorbs part of light with the first wavelength and emits light with a second wavelength. Light with the first wavelength and light with the second wavelength are mixed together to form mixed light with a second color temperature.

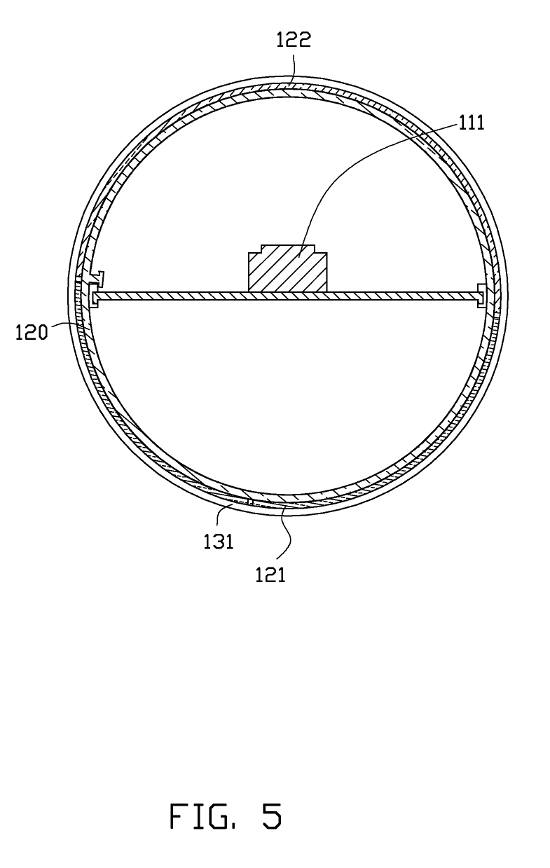

Referring to FIG. 5, to further adjust the color temperature of the LED tube 100, the housing 120 may be rotated to a second position where the plurality of LEDs 111 only faces the second phosphor layer 122, i.e., only the second phosphor layer 122 is in the illuminating area of the plurality of LEDs 111. The second phosphor layer 122 absorbs part of light with the first wavelength and emits light with a third wavelength. Light with the first wavelength and light with the third wavelength are mixed together to form mixed light with a third color temperature.

In the present disclosure, the housing 120 with the first and the second phosphor layers 121 and 122 deposited on the outer surface of the housing 120 may be rotated around the print circuit board 110 to obtain light with different color temperatures. To adjust the color temperature of the LED tube 100, the user only needs to rotate the housing 120 to a position corresponding to the color temperature, without replacing the whole LED tube 100. As a result, cost may be reduced.

The housing 120 may be rotated to other positions than the first position and the second position. When the illuminating area of the plurality of LEDs 111 are blocked by both the first phosphor layer 121 and the second phosphor layer 122, the color temperature of the LED tube 100 will change according to the ratio of coverage areas between the first phosphor layer 121 and the second phosphor layer 122. In other embodiments, three or more different phosphor layers may be arranged along a direction encircling the longitudinal central axis of the housing 120.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An LED tube, comprising:
a print circuit board comprising a plurality of LEDs arranged on one side;
a housing adapted to receive the print circuit board, the housing comprises a first phosphor layer and a second phosphor layer coated on an outer surface of the housing, the housing is rotatable around the print circuit board; and
a connector attached to one end of the housing, the connector is adapted to provide electrical power to the plurality of LEDs.

2. The LED tube of claim 1, wherein the first phosphor layer and the second phosphor layer are semi-circle cylindrical shaped and arranged on different portions of an outer surface of the housing.

3. The LED tube of claim 2, wherein the outer surface of the housing is divided into a first section and a second section by a plane passing through the longitudinal central axis, the first phosphor layer is formed on the first section, and the second phosphor layer is formed on the second section.

4. The LED tube of claim 1, wherein the connector comprises two securing sections, the securing sections are adapted to securely hold one end of the print circuit board.

5. The LED tube of claim 1, wherein the housing is tubular having two ends, each of the two ends is attached to the connector, and each of the two ends is rotatable around the connector.

6. The LED tube of claim 5, wherein the housing further comprises a protrusion inside the housing, the protrusion is adapted to limit a rotating angle of the housing.

7. The LED tube of claim 1, wherein the housing is made of polycarbonate or polymethyl methacrylate.

8. The LED tube of claim 1, wherein the connector comprises a base, and two electrode pins extending outwardly from a bottom of the base, the two electrode pins are adapted to be electrically connected with the plurality of LEDs.

9. The LED tube of claim 1, wherein a ratio of coverage areas between the first phosphor layer and the second phosphor layer illuminated by the plurality of LEDs is changeable by rotations of the housing.

10. The LED tube of claim 1, wherein the housing is rotatable among a normal position, a first position, and a second position, wherein the normal position is where both the first phosphor layer and the second phosphor layer are illuminated by the plurality of LEDs, the first position is where only the first phosphor layer is illuminated by the LEDs, and the second position is where only the second phosphor layer is illuminated by the LEDs.

11. An LED tube, comprising:
an LED for emitting light;
a tubular housing receiving the LED, the tubular housing is rotatable relative to the LED; and
a plurality of different phosphor layers formed on the tubular housing in sequences along a circumferential direction of the tubular housing.

12. The LED tube of claim 11, further comprising two connecters respectively attached to opposite ends of the tubular housing, the LED is fixed on one of the two connectors, and the tubular housing is rotatable relative to the two connectors.

13. The LED tube of claim 12, further comprising a printed circuit board having two opposite ends, wherein each of the two opposite ends is fixed to each of the two connectors, and the LED is fixed on the printed circuit board.

14. The LED tube of claim 13, each of the two connectors comprising a base, and two securing sections protruding from the base, wherein the base is attached to one end of the tubular housing, a gap between an outer edge of the base and the two securing sections is configured to receive the one end of the tubular housing.

15. The LED tube of claim 14, wherein each of the two opposite ends of the printed circuit board is attached to the two securing sections of each of the two connectors.

16. The LED tube of claim 14, the tubular housing further comprises a protrusion inside the tubular housing; the protrusion is adapted to limit a rotating angle of the tubular housing relative to the LED.

17. The LED tube of claim 16, the plurality of different phosphor layers comprise at least two different phosphor layers, the protrusion is formed at the joint of the at least two different phosphor layers.

18. An LED tube, comprising:
an elongated circuit board;
a plurality of LEDs fixed on one side of the circuit board;
a housing configured to receive the circuit board and the plurality of LEDs;
two connectors attached to opposite ends of the housing, wherein the housing is rotatably relative to the two connectors, each end of the elongated circuit board is attached to each of the two connectors; and
a plurality of different phosphor layers are formed on an outer surface of the housing in sequences along a circumferential direction of the housing.
